(19) United States
(12) Patent Application Publication
(10) Pub. No.: US 2025/0157803 A1
(43) Pub. Date: May 15, 2025

(54) Natural Isotopologues Based-Mass Spectrometer Calibration

(71) Applicant: DH Technologies Development Pte. Ltd., Singapore (SG)

(72) Inventors: Scott DANIELS, Concord (CA); Yongquan LAI, Cambridge, MA (US); Subhasish PURKAYASTHA, Concord (CA)

(73) Assignee: DH Technologies Development Pte. Ltd., Singapore (SG)

(21) Appl. No.: 18/722,148

(22) PCT Filed: Dec. 14, 2022
(86) PCT No.: PCT/IB2022/062239

§ 371 Date: Jun. 20, 2024

Related U.S. Application Data
(60) Provisional application No. 63/292,287, filed on Dec. 21, 2021.

(51) Int. Cl. H01J 49/00; G01N 30/62; G01N 30/72; G01N 30/88

(52) U.S. Cl. CPC H01J 49/0009; G01N 30/7233; G01N 30/88; G01N 2030/626; G01N 2030/8868

(57) ABSTRACT

In one aspect, a calibration mass standard for use in mass spectrometry is disclosed, which includes a plurality of natural isotopologues of a compound, where the natural isotopologues are present in the mass standard at relative concentrations corresponding to their natural atomic abundances.

### BACKGROUND

The present teachings are generally directed to mass standards for use in mass spectrometry as well as methods for calibrating, tuning and/or evaluating the performance of mass spectrometric systems that can employ such mass standards.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

Hence, there is a need for improved mass standards for use in mass spectrometry.

### SUMMARY

In one aspect, a mass standard for use in a mass spectrometric system is disclosed, which includes a plurality of natural isotopologues of a compound, where the natural isotopologues are present in the mass standard at relative concentrations corresponding to their natural atomic abundances. The mass standard may be employed, for example, for calibrating, tuning and/or evaluating the performance of a variety of different mass spectrometric systems.

In some embodiments, the natural abundances of the atomic isotopologues can be in a range of 0% to about 50%, e.g., in a range of about 0.1% to about 40%, or in a range of about 5% to about 30%.

A variety of compounds having natural isotopologues with different natural atomic abundances may be employed. One example of such a compound is Reserpine, which has several natural isotopologues with different natural abundances. Other suitable examples include, without limitation, n-dPEG36-amine, which has more than 8 natural isotopologues, and Triacetyl-β-cyclodextrin, which has more than 8 natural isotopologues.

In some embodiments, the mass standard, in addition to the plurality of the isotopologues present in their natural atomic abundances, can include a solvent. In many embodiments, the solvent can be selected such that it would not generate interfering mass peaks in a mass range associated with the isotopologues. Some examples of suitable solvents can include, without limitation, methanol, water and acetonitrile.

In some embodiments, the mass standard can include multiple compounds having different chemical structures and different masses, where each of those compounds has natural isotopologues with different natural atomic abundances. By way of example, the mass standard may contain two such compounds. In some implementations, the two compounds may be selected such that the mass of the heaviest isotope associated with the lighter compound is less than the mass of the lightest isotope associated with the heavier compound. In some such embodiments, the mass standard can include one set of natural isotopologues associated with one compound and another set of natural isotopologues associated with another compound, though more than two compounds may also be employed.

In a related aspect, a method of calibrating, tuning, and/or evaluating the performance of a mass spectrometric system is disclosed, which includes injecting a mass standard into a mass spectrometric system, where the mass standard comprises a plurality of natural isotopologues of a compound, where the natural isotopologues are present in the mass standard at relative concentrations corresponding to their natural atomic abundances. The mass spectrometric system can then be used to generate a mass spectrum of the compound, where the mass spectrum includes a plurality of mass peaks corresponding to the natural isotopologues of the compound. In an embodiment, the mass peaks can be utilized to calibrate, tune and/or evaluate the performance of the mass spectrometric system.

By way of example, calibration data, e.g., in the form of a calibration curve, can then be generated using the mass peaks. By way of example, the areas under the mass peaks, each of which can be indicative of the concentration of a respective isotopologue in the mass standard, can be employed for generating the calibration curve.

In some embodiments, the mass spectrometric system can include an LC column and/or a differential mobility mass spectrometer (DMS). In some embodiments, the mass spectrometric system can be an LC-MS system or an DMS-MS system, while in some embodiments the mass spectrometric system may include a mass spectrometer without an LC column or a DMS. The mass spectrometric system can include a variety of different types of mass analyzers. Some examples of such mass analyzers include, without limitation, quadrupole mass analyzers, time-of-flight (ToF) mass analyzers, and any combinations thereof. In some embodiments, such a mass analyzer can receive a sample from an upstream LC. Further, in some embodiments, the mass spectrometric system can be configured to perform tandem mass spectrometric analysis of a sample.

A variety of compounds having natural isotopologues with different natural atomic abundances can be employed in the practice of the present teachings. Some examples of suitable compounds include, without limitation, any of Reserpine, discrete PEG (polyethylene glycol) compounds, phosphazenes, peptides, e.g., iDP1.

Further understanding of various aspects of the present teachings can be obtained by reference to the following detailed description in conjunction with the associated drawings, which are described briefly below.

### BRIEF DESCRIPTION OF THE DRAWINGS

FIG. 1A schematically depicts an approach for MS calibration in which multiple standard mass samples are needed,

FIG. 1B schematically depicts MS calibration according to an embodiment of the present teachings in which a mass standard containing a plurality of the natural isotopologues of a compound at concentrations corresponding to their natural atomic abundances is employed,

FIG. 2 illustrates the molecular structure of Reserpine, a compound having a plurality of natural isotopologues with different natural atomic abundances, which can be incorporated into a single generic mass standard according to an embodiment of the present teachings,

FIG. 3 shows a hypothetical multi-point MS calibration curve that can be obtained via a single injection of a mass standard according to an embodiment,

FIG. 4A schematically depicts a hypothetical calibration of MS signal response at different molecular weight levels,

FIG. 4B schematically depicts an example of a hypothetical natural isotopologue-based calibration of MS signal response at different molecular weight and concentration levels according to an embodiment, and

FIG. 5 is a flow chart depicting various steps in a method according to an embodiment for calibrating/tuning/evaluating a mass spectrometric system using a plurality of natural isotopologues of a compound in a single mass standard.

### DETAILED DESCRIPTION

The operation of mass spectrometers typically requires calibration and optimization of the instrument parameters as well as evaluation of the instrument function. A variety of standard kits are available for calibrating, tuning and/or evaluating mass spectrometric systems. The inventors have recognized that traditional standard kits, however, suffer from a number of limitations.

For example, different models of mass spectrometric systems marketed by different vendors, or even the same vendor, may exhibit significantly different sensitivities. Currently, multiple mass standard kits are used for calibration/tuning and evaluation of the performance of mass spectrometric systems with different sensitivities to avoid weak and saturated signals. Specifically, mass standard kits containing references at a high concentration are employed to calibrate and test mass spectrometric systems having a low detection sensitivity.

In contrast, mass standard kits containing references at a low concentration are employed to calibrate and test mass spectrometric systems having a high detection sensitivity. As a result, the selection of a suitable standard mass kit for calibrating/tuning and/or evaluating a mass spectrometric system can be time consuming when an end user does not know the sensitivity of that mass spectrometric system. Consequently, the relationship between the response of a mass spectrometric system to different concentrations of mass standards is currently performed by analyzing multiple samples containing different levels of mass standards. The preparation of multiple standard samples is, however, time-consuming, labor intensive, and error prone.

The inventors have also recognized that the calibration of mass spectrometric systems using conventional reference standards can also be adversely affected by interferences, especially at low mass ranges (e.g., mass ranges less than about 400 Da), from contaminants, e.g., environmental contaminants as well as materials used for packaging standard solutions, etc. Such interferences may introduce mass peaks in calibration spectra, which may lead to incorrect calibration.

Further, the inability to accurately quantitate the compounds of a standard solution formulation during its manufacturing via methods other than mass spectrometry can compromise the accuracy and reproducibility of calibration/tuning/evaluation of mass spectrometric systems when using such a standard formulation as a calibrant. In particular, the absence of orthogonal quantitation methods may result in inaccurate concentrations of the compounds contained in a standard formulation. By way of example, if a compound is hygroscopic or its purity varies from lot to lot, its weight may not be a reliable measure to assure that a correct amount of that compound is incorporated in a standard formulation.

Moreover, manufacturing, validating and delivering multiple mass kits to end users increases the cost for instrument calibration and evaluation.

In some aspects, the present teachings provide a single generic mass standard kit for use in calibration and/or tuning and/or evaluation of mass spectrometric systems. By way of example, a mass standard according to an embodiment can be used for calibration and/or tuning and/or evaluation of mass spectrometric systems with different sensitivities.

In other words, rather than utilizing multiple mass standards for the calibration and/or tuning and/or evaluation of different mass spectrometric systems, e.g., mass spectrometric systems with different sensitivities, a single mass standard according to an embodiment can be used to calibrate and/or tune and/or evaluate a variety of different mass spectrometric systems. By way of example, the use of a single generic mass standard can advantageously eliminate the need for multiple mass standard kits and adjustment of the dilution factor for the standard, thereby significantly reducing the time and cost associated with the calibration and/or tuning and/or evaluation of mass spectrometric systems.

Various terms are used herein in accordance with their ordinary meanings in the art. The term “mass spectrometric system” is used herein broadly to refer to systems that include at least one mass analyzer for performing mass analysis of a sample (via the detection of ions generated by ionization of the sample and/or fragments of those ions). As noted above, some examples of such systems may further include a combination of an LC column and at least one mass analyzer. For example, a sample may be introduced into the LC column and the eluents exiting the LC column may be introduced into a downstream MS system for analysis. Further, as noted above, some such systems may include multiple mass analyzers, e.g., multiple quadrupole, time-of-flight (ToF) mass analyzers or combinations thereof, for performing tandem mass spectrometry. In other embodiments, a differential mobility spectrometer may be utilized as a front end in a mass spectrometer that allows for separation of different species based on differences in ion mobility. The term “about” as used herein is intended to indicate a variation of at most 10% around a numerical value. The term “and/or” includes any and all combinations of one or more of the associated listed items and may be abbreviated as “/”.

The sensitivity of a mass spectrometric system is defined herein in accordance with the common practice in the art as the electric charge of a specified ion species reaching an ion detector of the mass spectrometric system per mass of a target analyte introduced into the mass spectrometric system. The sensitivity of a mass spectrometric system may be provided in units of C/μg.

The separation observed in a mass spectrum between adjacent mass peaks is referred to as the mass resolution (R), which can be defined in accordance with common practice in the art as the smallest difference in m/z ratio between two ion species that can be separated for a given signal, i.e., at a given m/z value:

$$R = \frac{\frac{m}{z}}{Δ ( \frac{m}{z} )} \qquad Eq . ( 1 )$$

The term “substantially” as used herein indicates a deviation, if any, of at most 10% from a complete state and/or condition. The terms “mass standard” and “reference standard” as well as “standard reference” are used herein interchangeably to refer to a compound and/or formulation that can be employed for calibration, tuning and/or evaluation of a LC and/or a mass spectrometric system, which may include a mass spectrometer used with or without an LC column and/or a differential mobility spectrometer.

Further, in many embodiments, a compound for use in a mass standard according to an embodiment of the present teachings may be selected such that its natural isotopologues have masses where the background noise in a mass spectrum comprising mass peaks of its isotopologues, e.g., due to various interfering factors (such as contaminants), is minimal (and preferably not present). Further, in many embodiments, such a compound may be selected such that its concentration in the resultant mass standard can be quantified using methods other than mass spectrometry; that is, its concentration can be quantified using orthogonal methods, such as ultraviolet (UV) absorption. This can in turn allow generating more accurate and reproducible mass standards.

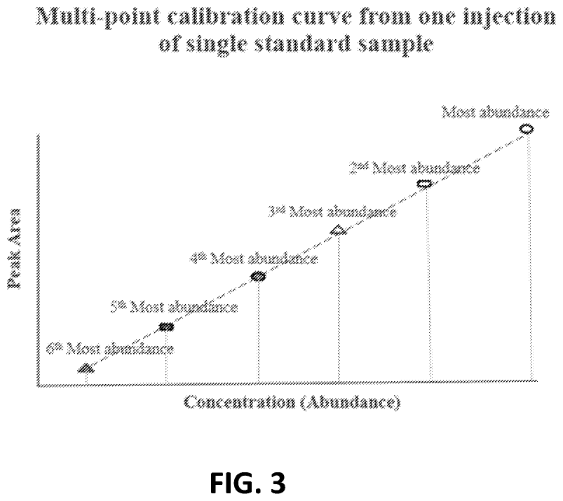

As noted above and discussed in more detail below, in an embodiment, a mass standard according to the present teachings for use in mass spectrometry, e.g., LC-MS or DMS-MS, can contain a plurality of different natural isotopologues of a compound at concentrations corresponding to their natural atomic abundances. In other words, a mass standard according to some embodiments can include different natural isotopologues of a compound at different concentrations. Such a mass standard can provide a number of advantages. For example, it can allow obtaining a multi-point calibration data, such as that shown in FIG. 3, via a single injection of a single mass standard sample rather than multiple injections of multiple mass standard samples, as is traditionally practiced. The reduction in preparation and injection of multiple mass standard samples to preparation and injection of a single mass standard sample can significantly increase the work flow efficiency and assay performance.

Further, as noted above, in at least some embodiments, the compounds for incorporation in a mass standard according to the present teachings can be selected to have masses in a region where the background noise (e.g., spurious mass peaks associated with contaminants, such as environmental contaminants) is minimal. In addition, in some embodiments, the compounds for incorporation in a mass standard according to the present teachings can be selected to allow easy quantification via methods that are orthogonal to mass spectrometric methods, such as UV absorption. Such selection of compounds for incorporation in a mass standard according to some embodiments of the present teachings can allow the preparation of more accurate and reproducible mass standard formulations with minimal and preferably no interferences. For example, previously-obtained data regarding mass peaks associated with various potential contaminants may be utilized to identify at least one mass region that is substantially free of such interfering mass peaks and the compound for use as a mass standard can be selected such that the masses of its natural isotopologues lie within that mass region.

The natural isotopologues of a compound have the same chemical structures but different masses. As such, they can be distinguished using mass spectrometry. In addition, natural isotopologues of a compound have very similar physicochemical properties, which can lead to similar sample extraction efficiency, chemical reaction and digestion efficiency, matrix effects and MS ionization efficiency. Therefore, low abundant natural isotopologues can be used as surrogate analytes to represent standards with low concentrations of a reference compound and high abundant natural isotopologues can be used as surrogate analytes to represent standards with high concentrations of a reference compound. That is, a single mass standard containing a plurality of natural isotopologues of a compound at relative concentrations corresponding to their natural atomic abundances can replace multiple concentrations of a standard mass compound. In other words, a single mass standard can represent a range of mass standards with different concentrations and can hence allow the calibration/tuning/evaluation of a range of mass spectrometric systems with different sensitivities.

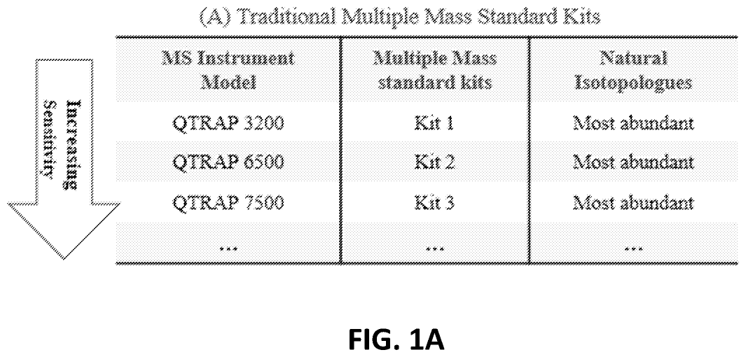

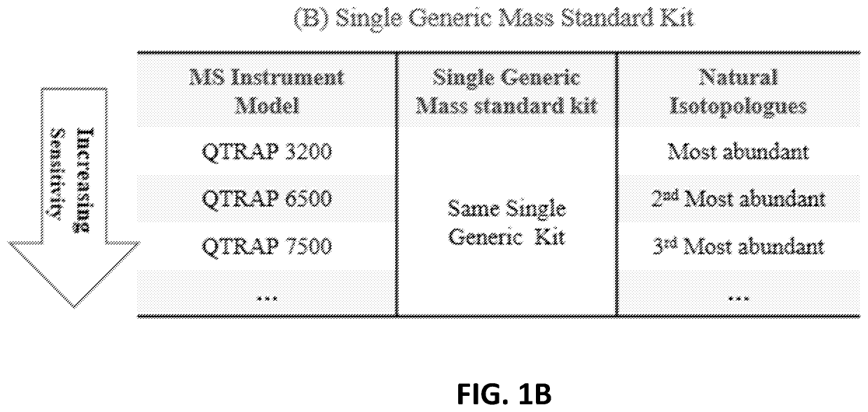

As shown in the table presented in FIG. 1A, in traditional calibration methods, only the most abundant natural isotopologue of a reference compound is used for instrument calibration. Consequently, different mass standard kits are needed in traditional methods for the calibration of a mass spectrometer. For example, mass standard kit 1 having the highest concentration of references can be used for calibration of mass spectrometric systems exhibiting a low sensitivity while the mass standard kit 3 with the lowest concentration of references can be used for calibration of sensitive instruments that exhibit a higher sensitivity.

In contrast, as shown in the table presented in FIG. 1B, only a single generic mass standard according to an embodiment of the present teachings having a plurality of natural isotopologues of a reference compound at concentrations corresponding to their natural atomic abundances is needed for the calibration and/or tuning and/or evaluation of a mass spectrometric system. For example, calibration/tuning/evaluation of a mass spectrometric system may be performed using natural isotopologues with appropriate natural atomic abundances depending on the specific instrument response, thereby eliminating the need for a change of mass standard kits or adjustment of the dilution factor of the standard.

In addition to calibration of mass resolution, a mass standard according to an embodiment can allow the evaluation of mass response at a specific molecular weight at multiple standard concentrations.

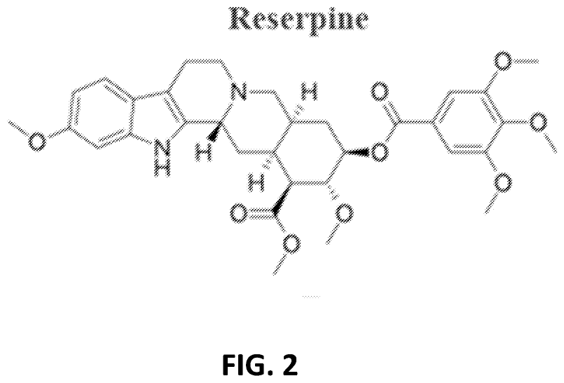

An example of a compound having a plurality of natural isotopologues with different relative natural atomic abundances that may be employed as a mass standard according to the present teachings is Reserpine (C33H41N2O9) having the chemical structure shown in FIG. 2. Reserpine includes five natural isotopes suitable for calibration/tuning/evaluation of low resolution mass spectrometric systems (e.g., those exhibiting a mass resolution less than about 10,000) and 14 natural isotopes for calibration/tuning/evaluation of high resolution accurate mass spectrometric systems (e.g., those exhibiting a mass resolution greater than about 10,000) with masses that range from 609 to 613. Table 1 below presents a list of these isotopes as well as their relative natural abundances.

TABLE 1

| | |
|---|---|
| Low Resolution | High Resolution |
| Natural Isotopologues | Natural Isotopologues |

| Natural | Relative | Natural | Relative |
|---|---|---|---|
| Isotop. | Abundance | Isotop. | Abundance |
| mass | (%) | mass | (%) |
| 609 | 100 | 609.28126 | 100 |
| 610 | 37.4 | 610.27829 | 0.7 |
| | | 610.28462 | 35.7 |
| | | 610.28547 | 0.4 |
| | | 610.28753 | 0.7 |
| 611 | 8.6 | 611.28165 | 0.3 |
| | | 611.2855 | 1.8 |
| | | 611.28797 | 6.2 |
| | | 611.28883 | 0.1 |
| | | 611.29089 | 0.2 |
| 612 | 1.3 | 612.28886 | 0.6 |
| | | 612.29133 | 0.7 |
| 613 | 0.2 | 613.29221 | 0.1 |
| | | 613.29468 | 0.1 |

A mass standard that includes a plurality of the above natural isotopologues of Reserpine at concentrations corresponding to their natural atomic abundances provides, in a single mass standard, multiple concentrations of Reserpine, each of which can be appropriate for use in calibrating and/or tuning and/or evaluating a class of mass spectrometric systems having a particular set of characteristics, such as sensitivity and resolution.

In some embodiments, a mass standard according to an embodiment can include multiple compounds with different masses, where each compound includes a plurality of natural isotopologues present at relative concentrations corresponding to their natural atomic abundances. Preferably, the differences between the masses of the compounds are sufficiently large such that there is a mass difference between the heaviest natural isotope and the lightest natural isotope of any two compounds having neighboring masses. For example, in some such embodiments, the different compounds can have masses in a range of about 50 to about 2000 amu, though other masses may also be employed in the formulation of the mass standard. For each compound in the mass standard, the associated natural isotopologues of that compound allow calibration of mass spectrometric instruments with different sensitivities, while the mass differences between the different compounds allow accurate calibration of a given mass spectrometric system.

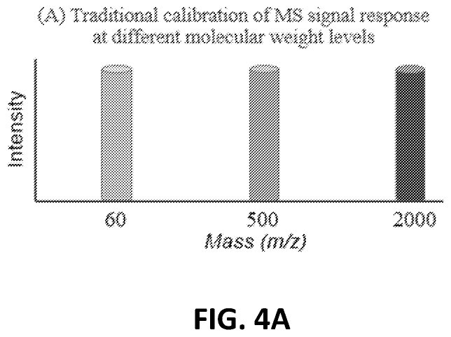

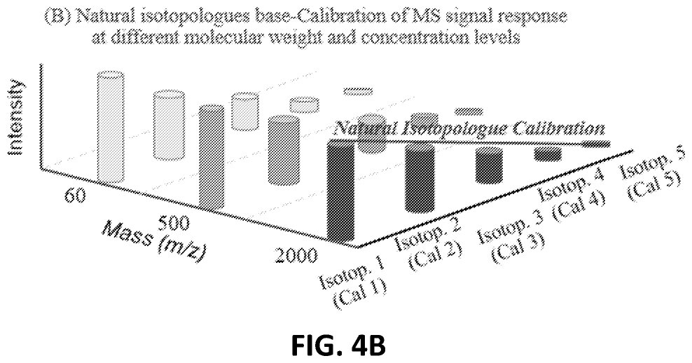

As shown schematically in FIG. 4A, in conventional calibration techniques, a mass spectrometer's response is evaluated at each molecular weight level at only one concentration. In contrast, FIG. 4B shows the use of an example of a hypothetical mass standard according to an embodiment of the present teachings for calibrating a mass spectrometric system, which includes three compounds at respective masses of 60, 500, and 2000, each of which includes five natural isotopologues that are present in the mass standard at relative concentrations corresponding to their natural atomic abundances.

The differences in the concentrations of the isotopologues of the compounds allow for the calibration/tuning/evaluation of mass spectrometric systems with different sensitivities/resolutions. For example, the isotopologues of the three compounds having the highest natural atomic abundances may be used for calibration/tuning/evaluation of mass spectrometric systems exhibiting a high sensitivity while the isotopologues having lower natural atomic abundances may be employed for the calibration/tuning/evaluation of lower sensitivity mass spectrometric systems.

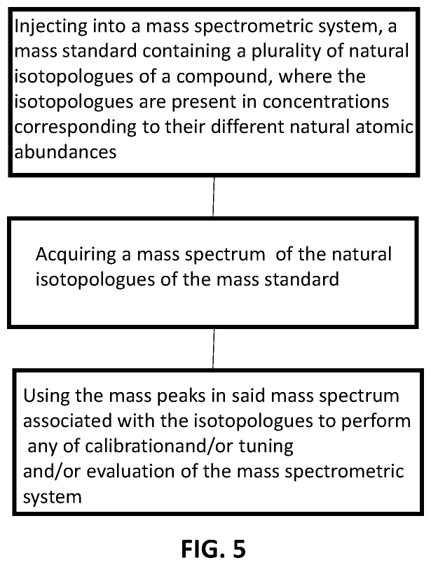

For example, with reference to the flow chart of FIG. 5, in a method for calibrating and/or evaluating and/or tuning a mass spectrometric system according to an embodiment, a single mass standard, which contains the natural isotopologues of a compound at their natural atomic abundances, can be injected into the mass spectrometer (step 1). The mass spectrometer can then be employed to obtain at least one mass spectrum of the natural isotopologues (step 2), and the mass spectrum can be analyzed to calibrate/tune/evaluate the mass spectrometric system (step 3).

By way of example, FIG. 3 depicts a hypothetical calibration curve generated by obtaining the peak area corresponding to the mass peak associated with each of six natural isotopologues of a compound used in a mass standard according to an embodiment. Such a hypothetical calibration curve can be employed to calibrate a mass spectrometric system. For example, such a calibration curve can allow correlating the area under a mass peak in a mass spectrum obtained by the mass spectrometric system with the concentration of an analyte to which that mass peak corresponds.

Hence, a mass standard according to embodiments of the present teachings can enhance MS calibration and/or performance, and/or reduce the cost of the mass standard kit.

A mass standard according to embodiments of the present teachings can be employed for calibrating and/or evaluating and/or tuning a variety of different mass spectrometric systems. Some examples of mass analyzers employed in such mass spectrometric systems include, without limitation, quadrupole, time-of-flight (ToF) mass analyzers and combinations thereof.

It is noted that in embodiments of the present teachings, calibration refers to the adjustment of the precision and accuracy of mass spectrometric analysis. Tuning can include calibration but can also refer to the adjustment of one or more operating parameters (such as detector voltage, resolution and mass offsets, declustering potential, and collision energy), e.g., in order to optimize mass peak intensity and/or peak width, and evaluation can include, e.g., overall performance tests to assess, e.g., system suitability with the entire system (MS+LC).

Instead of or in addition to using a mass standard according to embodiments of the present teachings for the calibration/tuning/evaluation of a mass spectrometer, in some embodiments, such a mass standard may be used for calibrating/tuning/evaluating the performance of a liquid chromatography (LC) column and/or LC-MS system. For example, in some embodiments, the retention times associated with the passage of different natural isotopologues of a mass standard through an LC column can be monitored to determine, e.g., whether the LC system is working properly or not (e.g., whether there is a need to replace the LC system).

In some embodiments, a mass standard can be used to calibrate/tune and/or evaluate the performance of an LC-MS system. By way of example, the mass standard may be employed to calibrate the MS system without the use of the LC system. Subsequently, the LC system may be connected to the MS system and the mass standard may be used to assess the performance of the entire LC-MS system. By way of example, some possible tests for the assessment of the LC-MS system may include the evaluation of the retention time, peak-to-peak resolution, peak shape and/or peak intensity.

In some embodiments, a mass standard can be used to calibrate/tune and/or evaluate the performance of a DMS-MS system. By way of example, the mass standard may be employed to calibrate the MS system without the use of the DMS system. Subsequently, the DMS system may be connected to the MS system and the mass standard may be used to assess the performance of the entire DMS-MS system. By way of example, some possible tests for the assessment of the DMS-MS system may include the evaluation of the compensation voltage, peak-to-peak resolution, peak shape and/or peak intensity.

Those having ordinary skill in the art will appreciate that various changes can be made to the above embodiments without departing from the scope of the present teachings.

What is claimed is:

1-9. (canceled)

10. A method of tuning or evaluating or adjusting a precision and an accuracy of a mass spectrometric system, comprising:
injecting a mass standard into a mass spectrometric system, wherein said mass standard comprises a plurality of natural isotopologues of at least one compound, said natural isotopologues being present in different natural abundances in said mass standard;
using said mass spectrometric system to generate a mass spectrum of said mass standard, wherein said mass spectrum comprises a plurality of mass peaks corresponding to said natural isotopologues; and
utilizing said plurality of mass peaks to perform any of tuning, evaluation and adjusting the precision and the accuracy of said mass spectrometric system.

11. The method of claim 10, further comprising utilizing said mass peaks to generate calibration data.

12. The method of claim 11, wherein the step of utilizing said mass peaks to generate said calibration data comprises determining a response or an area under at least one of said mass peaks corresponding to at least one of the natural isotopologues and correlating said response or mass peak area to the natural atomic abundance of said at least one of the natural isotopologues.

13. The method of claim 10, wherein said mass spectrometric system comprises an LC-MS system.

14. The method of claim 10, wherein said mass spectrometric system comprises any of a time-of-flight (ToF) mass analyzer, a quadrupole mass analyzer, and combinations thereof.

15. The method of claim 10, wherein said at least one compound comprises any of Reserpine, m-dPEG36-amine, and Triacetyl-β-cyclodextrin.

16-18. (canceled)

19. The method of claim 10 wherein said plurality of natural isotopologues are present in said mass standard at relative concentrations corresponding to their natural atomic abundances.

20. The method of claim 19 wherein five of the most abundant isotopologues in increasing order of said mass standard are utilized representing five concentrations in increasing order of said mass standard, respectively.

21. The method of claim 10, wherein utilizing said plurality of mass peaks to perform any of tuning, evaluation and adjusting the precision and the accuracy of said mass spectrometric system comprises:
utilizing a first mass peak, among the plurality of mass peaks, corresponding to a first natural isotopologue with the highest relative concentration among the plurality of natural isotopologues to perform any of tuning, evaluation and adjusting the precision and the accuracy of a first mass spectrometric system; and
utilizing a second mass peak, among the plurality of mass peaks, corresponding to a second natural isotopologue with the lowest relative concentration among the plurality of natural isotopologues to perform any of tuning, evaluation and adjusting the precision and the accuracy of a second mass spectrometric system,
wherein the first mass spectrometric system has lower sensitivity as compared to the second mass spectrometric system.

22. The method of claim 10 wherein the tuning or evaluating or adjusting the precision and the accuracy of a mass spectrometric system comprises adjusting one or more operating parameters of said mass spectrometric system.

23. The method of claim 22 wherein the one or more operating parameters is selected from detector voltage, resolution, mass offsets, declustering potential, and collision energy.

24. The method of claim 10 wherein the mass spectrometric system comprises a differential mobility mass spectrometer system (DMS-MS system) and wherein the tuning or evaluating or adjusting the precision and the accuracy of the mass spectrometric system includes assessment or adjusting of one or more operating parameters of said DMS-MS system.

25. The method of claim 24 wherein the one or more operating parameters is selected from the group consisting of compensation voltage, peak-to-peak resolution, peak shape, and peak intensity.

26. The method of claim 13 wherein the tuning or evaluating or adjusting the precision and the accuracy of a mass spectrometric system includes monitoring one or more of retention times, peak-to-peak resolution, peak shape and peak intensity of said plurality of natural isotopologues through a liquid chromatograph of said LC-MS system.

27. The method of claim 10, further comprising evaluating a mass response of the mass spectrometric system at a specific molecular weight using the mass standard.

28. A method of tuning or evaluating or adjusting a precision and an accuracy of a mass spectrometric system, comprising:
injecting a mass standard into a mass spectrometric system, wherein said mass standard comprises a plurality of compounds having differing masses, wherein each compound comprises a plurality of natural isotopologues that are present in the mass standard at relative concentrations;
using said mass spectrometric system to generate a mass spectrum containing each of said compounds, wherein said mass spectrum comprises a plurality of mass peaks corresponding to each of said natural isotopologues of each of said compounds, and
utilizing said plurality of mass peaks to perform any of tuning, evaluation, and adjustment of the precision and the accuracy of said mass spectrometric system.

29. The method of claim 28 wherein a difference in masses exists between at least two of the plurality of compounds, wherein a difference in masses for the at least two compounds is sufficiently large that there exists a mass difference between a heaviest isotope of one of said two compounds and a lightest isotope of the other of said two compounds.
